(19) United States
(12) Patent Application Publication
(10) Pub. No.: US 2005/0111844 A1
(43) Pub. Date: May 26, 2005

(54) Apparatus and method for providing HFC forward path spectrum

(75) Inventors: Charles L. Compton, Philadelphia, PA (US); Richard M. Woundy, North Reading, MA (US); John G. Leddy, Philiadelphia, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 10/723,806

(22) Filed: Nov. 26, 2003

(51) Int. Cl. H04J 14/00

(52) U.S. Cl. 398/70

(57) ABSTRACT

An apparatus for use in a hybrid fiber coax (HFC) network provides the HFC forward path spectrum from the head end to a network fiber node. The apparatus includes a head end modulator. The modulator directly receives a switchable digital data signal and internally processes the switchable digital data signal to produce the HFC forward path spectrum that directly drives the node. The HFC forward path spectrum may be directly converted to an analog optical signal by the modulator itself or by an optical conversion device immediately following the modulator.

### BACKGROUND OF THE INVENTION

1. Field of the Invention

The invention relates to hybrid fiber coax (HFC) networks and to broadcast and narrowcast signal distribution technologies.

2. Background Art

The modern hybrid fiber coax (HFC) network in its typical implementation includes fiber from the head end to the local network fiber node, and includes coax cable for the final signal distribution through a neighborhood. Modern two-way HFC infrastructures are capable of sending gigabits of data per second to small pockets of homes in a narrowcast way. Narrowcast, as opposed to broadcast, means that the sent information is direct or casted to a specific user or group of users as opposed to traditional broadcasting to all users. However, the reality with traditional head end equipment is that only a fraction of this bandwidth can be economically used.

Traditional approaches at the head end use radio frequency (RF) combining networks to combine and upconvert signals. RF combining networks in the head end are complex and time consuming to reconfigure in response to changes in bandwidth needs. The way that traditional modulators in the RF combining networks are typically wired to the physical HFC plant is a static configuration that limits the flexibility that can be achieved in the HFC network. The static configuration limits the economic use of bandwidth.

Cost-effective switchable technologies (such as 1 GigE and 10 GigE) that have been developed in recent years could possibly provide increased flexibility at the head end. There has been an approach in edge QAM modulators where block upconversion was used to upconvert 2-4 6-megahertz channels at once from Ethernet input. However, the upconversions in this approach produce an RF output that must be provided to the traditional RF combining networks, and thus the existing use of block upconversion is still subject to the limitations of the RF combining networks which reduce the amount of HFC network bandwidth that can be economically used.

For the foregoing reasons, there is a need for an improved approach to signal distribution in an HFC network that simplifies operations.

### SUMMARY OF THE INVENTION

It is an object of the invention to provide an improved apparatus and method for providing the HFC forward path spectrum.

In carrying out the invention, an apparatus is provided. The invention comprehends an apparatus for use in a hybrid fiber coax (HFC) network to provide the HFC forward path spectrum from the head end to a network fiber node. The apparatus comprises a head end modulator. The modulator directly receives a switchable digital data signal and internally processes the switchable digital data signal to produce the HFC forward path spectrum that directly drives the fiber node. The HFC forward path spectrum may be directly converted to an analog optical signal by the modulator itself or by an optical conversion device immediately following the modulator.

It is appreciated that the modulator produces the entire or essentially entire HFC forward path spectrum (for example, 50-750 megahertz). Put another way, the produced forward path spectrum directly drives the fiber node in that it does not need to pass through any RF combining network.

It is appreciated that the modulator receives the switchable digital data signal and produces the HFC forward path spectrum that drives the node, eliminating many complications that are typically associated with traditional RF combining network approaches at the head end.

In a preferred embodiment, the head end modulator generates the analog optical signal. Further, the modulator may process the digital data signal to dynamically allocate bandwidth to different services (for example, customer-originated bandwidth requests for video on demand, switched broadcast, or DOCSIS, etc. as well as operator-originated channel lineup changes). In this way, a total narrowcast approach is possible. The invention also comprehends receiving the switchable digital data signal in the form of 1 GigE or 10 GigE, and receiving the switchable digital signal as one or a plurality of Ethernet or other switchable digital single inputs. Further, the invention also comprehends that the switching may be at a higher level (than GigE). For example, switching may take place at Internet Protocol (IP) level or even at a content routing level with the critical aspect being the production of the HFC forward path spectrum from the switched and digital data signal.

Further, in carrying out the invention, a method is provided. The method is for use in a hybrid fiber coax (HFC) network to provide the HFC forward path spectrum from the head end to a fiber network node. The method comprises directly receiving, at a head end modulator, a switchable digital data signal. The method further comprises processing the switchable digital data signal at the head end modulator to produce the HFC forward path spectrum that directly drives the network fiber node.

It is appreciated that the invention comprehends using one of the head end modulators for each service group, which could be as small as a single HFC node.

Further, in carrying out the invention, a system for use in a hybrid fiber coax (HFC) network to provide the HFC forward path spectrum from the head end to a plurality of network fiber nodes is provided. The system comprises a plurality of head end modulators. Each modulator directly receives a switchable digital data signal and internally processes the switchable digital data signal to produce the HFC forward path spectrum that directly drives an associated network fiber node. Each individual modulator processes its received switchable digital data signal to dynamically allocate bandwidth to different services to provide an essentially narrow cast approach among the plurality of modulators.

The advantages associated with embodiments of the present invention are numerous. The head end modulator may eliminate the traditional difference between broadcast and narrowcast to enable the full flexibility of a switched environment to be realized in an HFC infrastructure. The head end modulator may simplify signal distribution operations by eliminating the RF combining networks. The invention allows existing HFC plant to be used with a flexible mechanism for dynamically allocating bandwidth to different services.

### BRIEF DESCRIPTION OF THE DRAWINGS

FIG. 1 illustrates a signal distribution network made in accordance with the invention;

FIG. 2 illustrates an alternative signal distribution network made in accordance with the invention;

FIG. 3 illustrates a system of the invention wherein a plurality of head end modulators provide an essentially narrow cast approach among themselves; and

FIG. 4 is a block diagram illustrating a method of the invention.

### DETAILED DESCRIPTION OF THE PREFERRED EMBODIMENTS

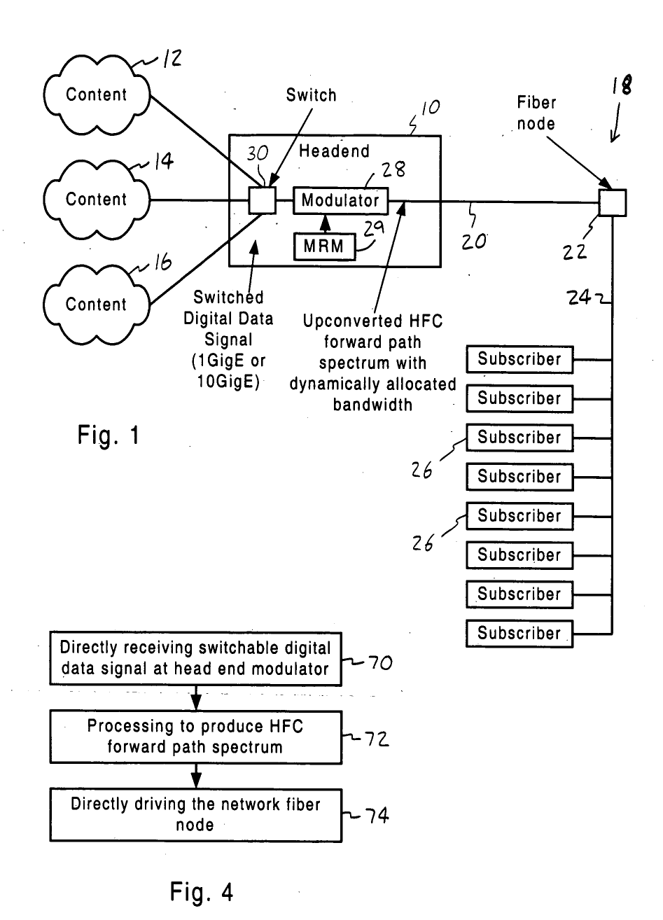

FIG. 1 illustrates signal distribution by head end 10. Head end 10 receives content from sources 12, 14, 16. Content may include services, data, or other information. For example, telephony services, high speed data services, and interactive video services are all a possible content. A modern hybrid fiber coax (HFC) network is generally indicated at 18. HFC network 18 includes fiber 20 from head end 10 to local network fiber node 22, and includes coax cable 24 for the final signal distribution through a neighborhood to subscribers 26. Coax cable 24 may include amplifiers. Head end modulator 28 provides the HFC forward path spectrum from head end 10 to fiber node 22. Modulator 28 directly receives a switchable digital data signal from switch 30. Modulator 28 internally processes the switchable digital data signal to produce the HFC forward path spectrum. Modulator 28 may directly convert the HFC forward path spectrum to an analog optical signal as illustrated. Alternatively, an optical conversion device may immediately follow modulator 28.

Modulator 28 advantageously produces the entire or essentially entire HFC forward path spectrum. For example, the spectrum may be the 50-750 megahertz spectrum. The produced forward path spectrum directly drives fiber node 22 and traditional RF combining networks are not required. Accordingly, the flexibility limitations associated with traditional RF combining networks are not present. Modulator 28 may process the digital data signal to dynamically allocate bandwidth to different services. This approach produces a total narrowcast arrangement, as opposed to the complex combination of broadcast and narrowcast distribution associated with traditional RF combining networks. Modulator resource manager 29 grants (or rejects) customer and operator initiated bandwidth requests, and maps granted requests into modulator spectrum allocations.

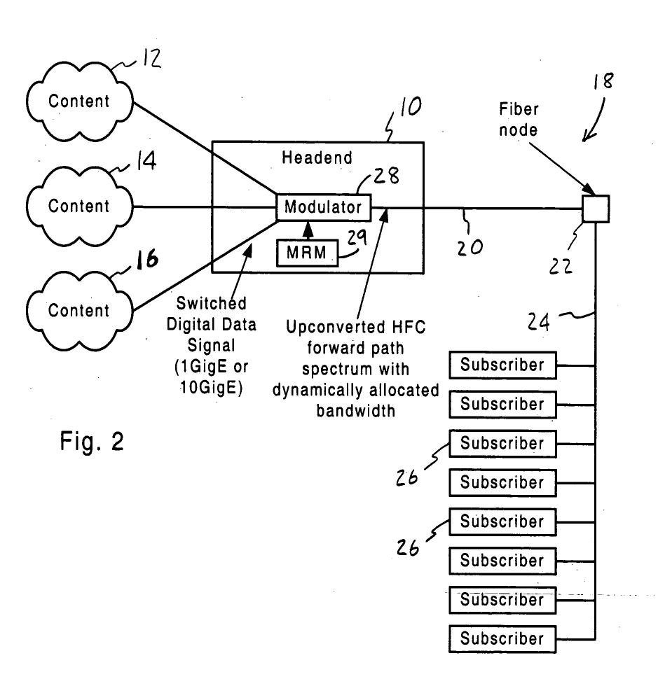

The switched digital data signal is preferably 1 GigE or 10 GigE. FIG. 1 illustrates modulator 28 receiving a single switched digital data signal. Alternatively, and as best shown in FIG. 2, a plurality of switchable digital data signal inputs may be received by modulator 28. Of course, the invention also comprehends that the switching may be at a higher level such at Internet Protocol (IP) level or even at a content routing level. Further, the content itself is not restricted in its form. That is, the content may be digital content such as MPEG2 or data but may also include, for example, some analog channels. These channels could be sampled and sent digitally to the modulator for processing into the correct channel slot/frequency range. Lastly, it would also be possible for the modulator to accept some analog channels in the way just described, and perform the sampling internally.

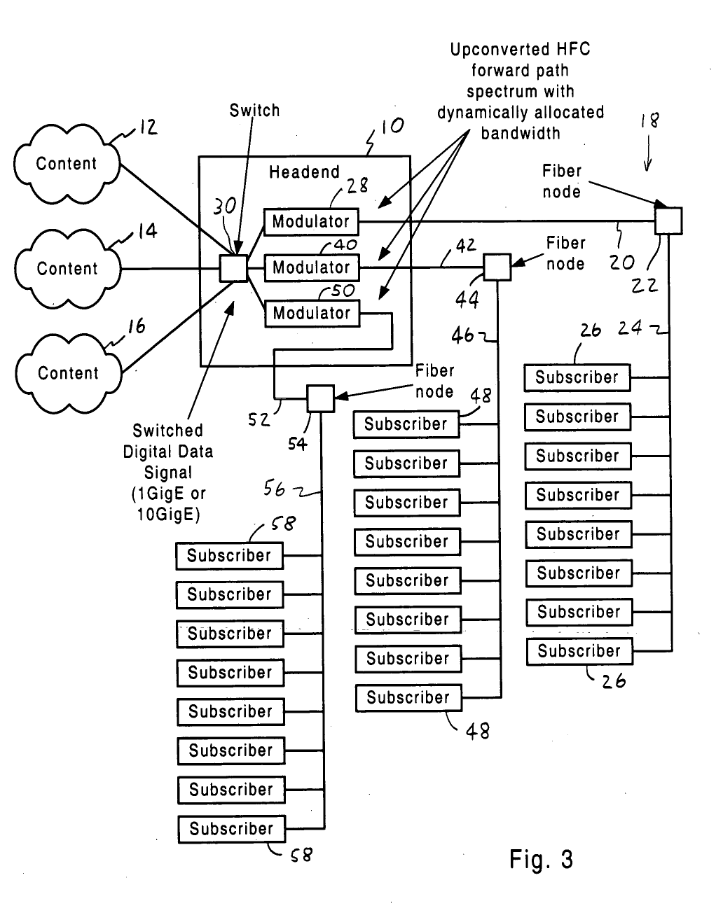

FIG. 3 illustrates a system wherein a plurality of head end modulators provide an essentially narrowcast approach among themselves. In FIG. 3, head end 10 includes modulator 28 and further includes modulator 40 and modulator 50. Modulator 40 directly receives a switchable digital data signal and produces the HFC forward path spectrum that directly drives fiber node 44. Modulator 50 directly receives a switchable digital data signal and produces the HFC forward path spectrum that directly drives fiber node 54. Although not specifically illustrated, one or more modulator resource managers are also present at headend 10.

More specifically, modulator 40 is connected by fiber 42 to fiber node 44, and the final distribution leg 46 is over coax to subscribers 48. Modulator 50 is connected by fiber 52 to fiber node 54. The final distribution leg 56 is over coax 56 to subscribers 58. Each modulator 28, 40, 50 processes its received switchable digital data signal to dynamically allocate bandwidth to different services to provide an essentially narrowcast approach among the plurality of modulators.

FIG. 4 illustrates a method. Block 70 illustrates the direct receiving of a switchable digital data signal at a head end modulator. Block 72 illustrates processing the received switchable digital data signal to produce the HFC forward path spectrum. Block 74 illustrates directly driving the associated network fiber node with the HFC forward path spectrum.

Embodiments of the present invention have a number of advantages, including the fact that the head end modulator may eliminate the traditional difference between broadcast and narrowcast to enable the full flexibility of a switched environment to be realized in an HFC infrastructure. More specifically, the head end modulator may simplify signal distribution operations by eliminating the RF combining networks. Embodiments of the present invention allow existing HFC plant to be used with a flexible mechanism for dynamically allocating bandwidth to different services.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. An apparatus for use in a hybrid fiber coax (HFC) network to provide the HFC forward path spectrum from the head end to a network fiber node, the apparatus comprising:
a head end modulator directly receiving a switchable digital data signal and internally processing the switchable digital data signal to produce the HFC forward path spectrum that directly drives the network fiber node.

2. The apparatus of claim 1 wherein the head end modulator generates an analog optical signal for the network fiber node.

3. The apparatus of claim 1 wherein the head end modulator processes the switchable digital data signal to dynamically allocate bandwidth to different services.

4. The apparatus of claim 1 wherein the switchable digital data signal is received in the form of a 1 GigE signal.

5. The apparatus of claim 1 wherein the switchable digital data signal is received in the form of a 10 GigE signal.

6. The apparatus of claim 1 wherein the switchable digital data signal is received as a single digital data signal input.

7. The apparatus of claim 1 wherein the switchable digital data signal is received as a plurality of digital data signal inputs.

8. A method for use in a hybrid fiber coax (HFC) network to provide the HFC forward path spectrum from the head end to a network fiber node, the method comprising:
directly receiving a switchable digital data signal at a head end modulator; and
processing the switchable digital data signal, at the head end modulator, to produce the HFC forward path spectrum that directly drives the network fiber node.

9. The method of claim 8 further comprising:
generating an analog optical signal, with the head end modulator, for the network fiber node.

10. The method of claim 8 wherein the head end modulator processes the switchable digital data signal to dynamically allocate bandwidth to different services.

11. The method of claim 8 wherein the switchable digital data signal is received in the form of a 1 GigE signal.

12. The method of claim 8 wherein the switchable digital data signal is received in the form of a 10 GigE signal.

13. The method of claim 8 wherein the switchable digital data signal is received as a single digital data signal input.

14. The method of claim 8 wherein the switchable digital data signal is received as a plurality of digital data signal inputs.

15. A system for use in a hybrid fiber coax (HFC) network to provide the HFC forward path spectrum from the head end to a plurality of network fiber nodes, the system comprising:
a plurality of head end modulators, each modulator directly receiving a switchable digital data signal and internally processing the switchable digital data signal to produce the HFC forward path spectrum that directly drives an associated network fiber node,
wherein each individual modulator processes its received switchable digital data signal to dynamically allocate bandwidth to different services to provide an essentially narrow cast approach among the plurality of modulators.

16. The system of claim 15 wherein each head end modulator generates an analog optical signal for the associated network fiber node.

17. The system of claim 15 wherein the switchable digital data signal is received in the form of a 1 GigE signal.

18. The system of claim 15 wherein the switchable digital data signal is received in the form of a 10 GigE signal.

19. The system of claim 15 wherein the switchable digital data signal is received as a single digital data signal input.
